(19) United States
(12) Patent Application Publication
(10) Pub. No.: US 2014/0379595 A1
(43) Pub. Date: Dec. 25, 2014

(54) ASSOCIATING LICENSES OF A COMPUTER PRODUCT WITH A PURCHASER OF THE COMPUTER PRODUCT VIA AN N-TIER CHANNEL

(71) Applicant: CISCO TECHNOLOGY, Inc., San Jose, CA (US)

(72) Inventors: Ian SLATTERY, San Jose, CA (US); Vincent NOLAN, San Jose, CA (US)

(21) Appl. No.: 13/924,584

(22) Filed: Jun. 23, 2013

(51) Int. Cl. G06Q 30/00

(52) U.S. Cl. CPC G06Q 30/0185
USPC 705/318

(57) ABSTRACT

Techniques are provided for associating license entitlements to a customer of computer software or hardware in a multi-tiered distribution channel. A partner of a vendor places an order for computer products on behalf of the end user customer. The order may go through several distribution channels before the vendor receives the order. Upon receiving the order, a vendor license manager generates entitlements based on the order and prompts the partner to provide a customer identifier corresponding to a customer account maintained on the vendor cloud. Once the license manager receives the customer identifier, the license manager provisions the license entitlements to the customer account.

### TECHNICAL FIELD

The present disclosure relates generally to licensing computer software or hardware. More specifically, techniques are disclosed for provisioning license entitlements for computer software or hardware to an end customer via a multi-tier distribution channel.

### BACKGROUND

Traditionally, licenses for computer software and hardware have been provided to end user customers via a product activation key (PAK). A PAK is a code, ordered in the same manner as computer equipment for example, that a customer uses to enable, activate, or access features on computer products. The customer associates a PAK with a specific software product, software feature, or hardware device. Accordingly, the customer proves product ownership directly for every single software installation instance on a hardware device, and possibly for the hardware device itself. For example, a user may activate a network router by keying in a PAK. Alternatively, the user may register the PAK and receive a license key file that the user installs in a specified location on the device. This licensing approach delegates decisions to enforce the software license into the hardware device (e.g., switch, router, etc.).

However, such an approach is problematic because, where many computer products are being licensed, the vendor may be unable to determine the actual customer of a product based on activation via a PAK. When a customer activates a computer product using a PAK, typically the vendor only knows that the computer product has been activated on a particular device, but not the owner of the product license. This issue is further complicated in a multi-tier distribution channel, where the vendor is disconnected from the customer by several intermediaries. For example, large vendors establish partnerships with distributors and resellers that, in turn, have direct commerce relationships with the customer (or other sub-distributors). In some cases, a reseller may activate a purchased computer product on behalf of the customer. For instance, assume a reseller purchases, from the vendor (or a distributor of the vendor), ten instances of software to be used in routers in a customer enterprise network (along with purchasing the routers as well). Before shipping the routers to the enterprise, the reseller activates and registers the software so that the enterprise may use the routers immediately. In this case, the vendor might know that the router software has been activated, and that the license terms and conditions have been accepted, but the vendor cannot directly ascertain the end user of the routers.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example chain of computer product delivery from a vendor to a customer in a multi-tiered channel under an example licensing model, according to one embodiment.

FIG. 2 illustrates an example account of a customer enrolled with a vendor in an example licensing model, according to one embodiment.

FIG. 3 illustrates a method diagram for provisioning and associating license entitlements of a computer product to a customer under an example licensing model, according to one environment.

FIG. 4 illustrates a sequence diagram of provisioning and associating license entitlements to a customer, from the customer placing an order for a computer product to a license manager associating the entitlements, according to one embodiment.

FIG. 5 illustrates a vendor server computing system configured to provision and associate license entitlements to a customer, according to one embodiment.

FIG. 6 illustrates an example router product of a vendor that is configured to monitor and track customer use of entitlements, according to one embodiment.

### DESCRIPTION

### Overview

Embodiments presented herein include a method. This method generally includes receiving purchase information for computer products from a partner of a vendor. The partner sends the purchase information to the vendor on behalf of a customer. Once the purchase information has been received, the method includes generating, based on the purchase information, license entitlements and a token. The token is associated with the license entitlements and is used by the partner to access the license entitlements. The method also includes sending the token to the partner and receiving, from the partner, a customer identifier. Upon identifying the customer account corresponding to the customer identifier, the license entitlements are provisioned to a set of one or more license entitlements associated with the account.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### Description of Example Embodiments

Embodiments presented herein provide techniques for associating license entitlements for computer software or hardware to a customer. In one embodiment, a customer places an order to an intermediary partner of a vendor. The intermediary partner sends the order to the vendor. A vendor license manager (i.e., software applications running on a server managed by the vendor) generates license entitlements for the order and sends the license entitlements to the intermediary partner. Upon receiving the license entitlements, the partner assigns the entitlements to the customer (e.g., by sending a response to the vendor license manager with an identifier corresponding to the end-user customer). Thereafter, the vendor license manager associates the entitlements to the customer (e.g., by provisioning the license entitlements to a license pool associated with the customer account).

Embodiments provide a computer product licensing model where a customer and intermediary partners (e.g., distributors and resellers) of a vendor enter into an agreement with the vendor. Under this model, a customer purchases computer products (e.g., computer software or hardware) and agrees to allow the vendor to track and report the use of licenses or other entitlements related to the products, such as through a license manager device residing on a vendor-side server. The license manager generates a customer account associated with the purchases of the customer. The customer account includes pools of licenses for the computer products that include entitlements specifying privileges the customer receives with respect to product use.

Under this model, the license manager generates entitlements and associates the entitlements to an account of the customer. The resulting entitlements may be stored in a database in the vendor cloud. In a 1-tier channel, where the vendor has a direct commerce relationship with the customer, the vendor may simply associate the entitlements with the customer upon purchase and activation of computer software or hardware, because the vendor already knows the end-user of the product. However, in an N-tier channel, where one or more intermediary parties separate the customer and the vendor, the purchasing party (e.g., a reseller) activates the computer product on behalf of the customer. In this case, the reseller may provide the license manager with a corresponding customer identifier and authentication and the license manager then associates license entitlements for the customer.

Advantageously, embodiments disclose techniques for rendering controlled activation and entitlement usage for vendor computer products. The techniques allow a vendor to ascertain, even if the vendor and customer are separated by one or more channels, the identity of a customer, license entitlements owned by the customer for product purchases, and the entitlements that a customer is using and not using. Further, by tying product registrations to a particular customer account rather than an individual device, this approach provides support for associating license entitlements that are stored and maintained, for example, in a vendor cloud network.

In the following, an example of hardware routers and switches are used as reference examples of provisioning license entitlements for a computer product to a customer license pool. This reference example is included to provide a better understanding of the embodiments described herein. However, it will be apparent to one of skill in the art that these embodiments are applicable to other computer hardware or software products (e.g., software applications installed on a server, firewalls, etc.).

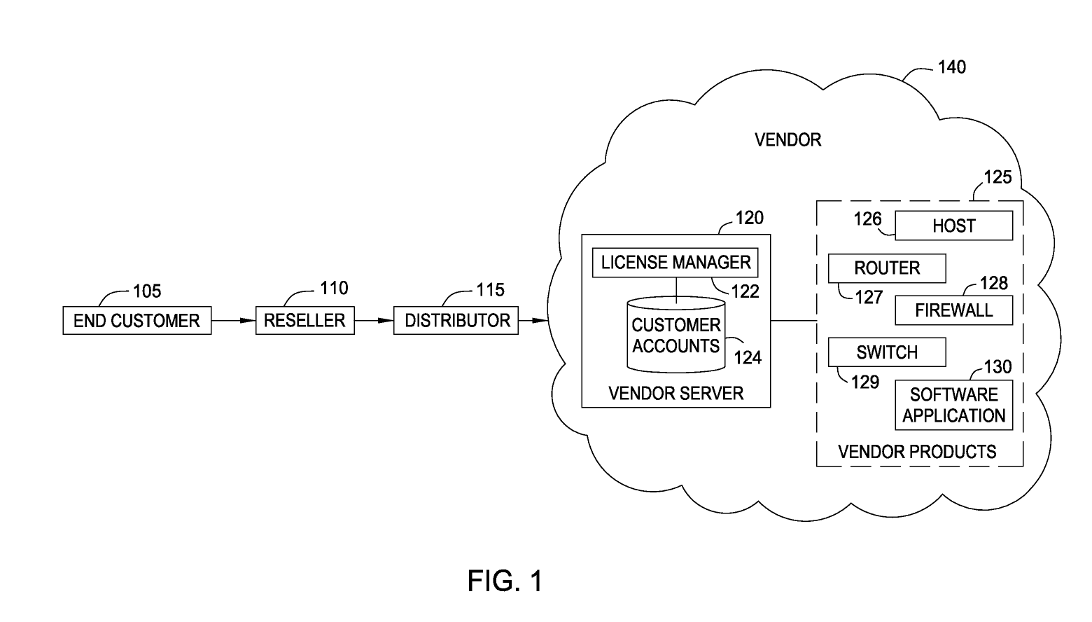

FIG. 1 illustrates a conceptual diagram of the relationships between trusted parties in a computer product license environment, according to one embodiment. The trust model may include a customer 105, a reseller 110, and a distributor 115. Customer 105 has agreed to enter the licensing model with vendor 140. Vendor 140 maintains a server 120 within a cloud network. For simplicity, FIG. 1 depicts reseller 110 and distributor 115 as the only intermediate parties between customer 105 and vendor 140. Of course, the embodiments may be applied in situations with fewer or more intermediary parties than depicted in FIG. 1.

As shown, the vendor has computer products 125 available for purchase. For example, computer products 125 may include a host 126, a router 127, a firewall 128, a switch 129, and a software application 130, among other products. A customer 105 purchases computer products 125 through reseller 110. In turn, reseller 110 fulfills the order by purchasing products from a distributor 115 that acquires products directly from vendor 140. For example, customer 105 may purchase fifteen routers 129 manufactured by vendor 140. To do this, customer 105 places an order with reseller 110 (e.g., through an online form or website), providing reseller 110 with order specifications for the fifteen routers (e.g., configurations, customer information, and the like). Reseller 110 purchases the fifteen routers from distributor 115 and delivers the order to customer 105. Thereafter, distributor 115 may notify vendor 140 during an inventory report of the sale of the fifteen routers.

A license manager 122 residing in memory of a server computing system of vendor 140 may associate customer purchases to customer 105. To activate a computer product under this licensing model, customer 105 registers the purchase with license manager 122 (e.g., through a graphical user interface on a customer management application). In one embodiment, reseller 110 does this on behalf of customer 105. A registration of a purchase 140 may include an identifier of a product (or instance of the product) and a customer identifier, among other information. After license manager 122 receives purchase records and the product registrations, license manager 112 associates the registration and license entitlement data with a license pool belonging to a customer account 124.

In one embodiment, computer purchases 140 are associated with a customer account 124. Customer account 124 includes one or more license pools. A license pool is a logical grouping of software license entitlements and product instances associated with customer account 124. A license entitlement, as described below, corresponds to a set of privileges received when purchasing a license.

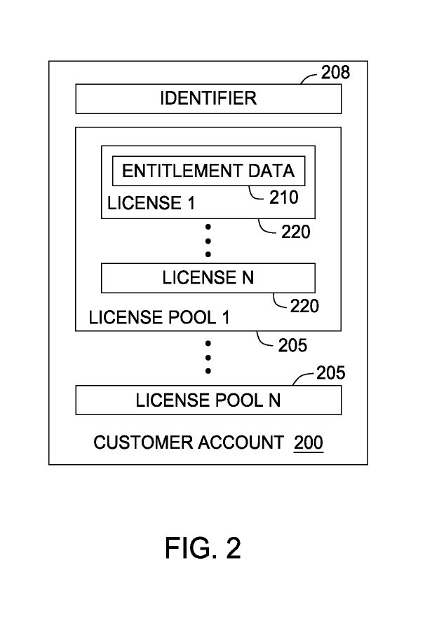

FIG. 2 further illustrates a customer account 200, according to one embodiment. In one embodiment, a vendor-side server computing system maintains customer accounts 200 in a database on the vendor cloud. Illustratively, customer account 200 may include one or more license pools 205. As noted above, a license pool 205 is a grouping of licenses and product instances 220. In one embodiment, a license pool 205 may be categorized by product line. For example, a license pool 205 may correspond to a group of licenses for datacenter products, while another license pool 205 may correspond to a group of licenses for telecommunications products. More generally, each license pool may relate to a common set of software products.

Each license 220 includes an identifier 208 and entitlement data 210. An entitlement is a set of privileges associated with a particular computer software or hardware license. Examples of entitlement data 210 may include the right to use software or access software subscriptions, to enable specific features of a hardware/software product, specify a number of installation instances (or “seats”) for a software application, specify content that the customer may access, upgrades that the customer may make, the duration that the customer is allowed to use the product, among other rights. For example, license entitlement data 210 for a software-based (i.e., virtual) router may specify that the customer is allowed to have up to five open ports. As another example, license entitlement data 210 of a firewall may specify that a customer can have up to ten connected devices per firewall. In one embodiment, entitlement data 210 is dynamic. That is, if a customer, for example, makes additional purchases of a software instance or decommissions end-devices, the entitlement data 210 changes to reflect the additions, deletions, etc.

A license manager residing in memory of a server in the vendor cloud associates entitlement data 210 to a particular customer account 200 upon registration of a particular computer product. This allows a vendor to track the license entitlements of each customer and the customer usage of the license entitlements. Because not all customers activate a computer product directly (i.e., an intermediate partner such as a reseller does this on behalf of the customer), the intermediate partner is responsible for communicating customer information to the license manager when placing an order for the customer.

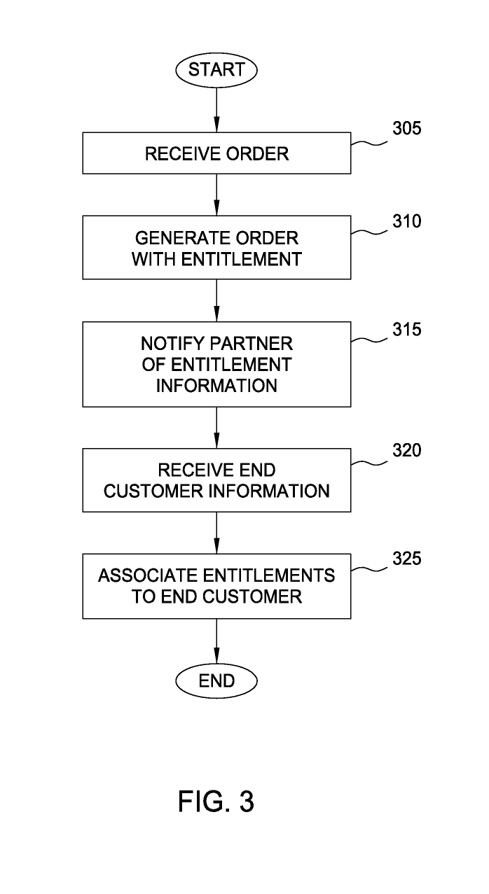

FIG. 3 illustrates a method 300 for associating and provisioning license entitlements to a customer account, according to one embodiment. The method begins at step 305, where the vendor license manager receives an order from a channel partner, such as from a distributor. The order information may include a notification identifier (such as an e-mail address) of a partner reseller who made the purchase for a customer. Upon receiving the order, the license manager generates entitlements for the order (step 310). The license manager may generate the entitlements in real-time based on order specifications. For example, if a customer orders fifty instances of a software-based router (i.e., a virtual router), the entitlements may specify that the end user customer may use up to fifty instances of the virtual router and that using additional instances is an overage situation. A vendor may specify an overage allowance for a certain product (or alternatively, a customer may specify an overage allowance in the order specification) that is reflected in the entitlements generated by the license manager.

The license manager provides the entitlement data to the reseller and notifies the partner of the entitlements (step 315). In one embodiment, the license manager generates a token associated with the entitlements and includes the token with the notification. The token serves as proof of entitlement to the customer. Further, the token can be passed through each distribution channel. For example, if a customer order goes through more than one reseller before finally reaching the vendor, each channel has a clear view of the entitlements associated with the token. In one embodiment, the license manager may generate and send an e-mail to the reseller (using the identifier provided by the distributor) with the token embedded in a uniform resource locator (URL) link to a vendor portal. If the reseller clicks on the link having the embedded token, the license manager associates the token with the entitlements, and thereafter the reseller is able to view the entitlement data and also provide information about the customer's account to validate the entitlements against the account. In another embodiment, the vendor may print a URL with the embedded token on a document mailed to the reseller. In turn, the reseller enters the URL from the physical document in a web browser activate the product and provision the entitlements. In an alternative embodiment, the vendor may send the e-mail or physical document to the customer, enabling the customer to self-register the product and provision the entitlements.

At step 320, the vendor license manager receives information for assigning entitlements to a particular customer from the reseller. The information may include an identifier corresponding to a customer account maintained by the license manager. At step 325, the license manager uses this information to associate the entitlements to the customer. The license manager also provisions the entitlements to a license pool (e.g., stored in a network accessible repository) in the corresponding customer account (step 325). That is, the license manager assigns the license entitlements associated to the customer to a particular license pool. As a result, by referring to the customer account, a vendor may be able to ascertain the identity of the customer, the amount of entitlements provisioned per product, the entitlements that the customer is using, and the entitlements that the customer is not using, among others. The vendor may use this information in auditing customer use of the associated computer product and enforcing proper use within the license entitlements (e.g., in monitoring for overages). Additionally, a customer may also review associated entitlements and track usage (e.g., to stay within bounds of the entitlements or determine where overages have occurred) once the license manager has associated the entitlements to the customer account.

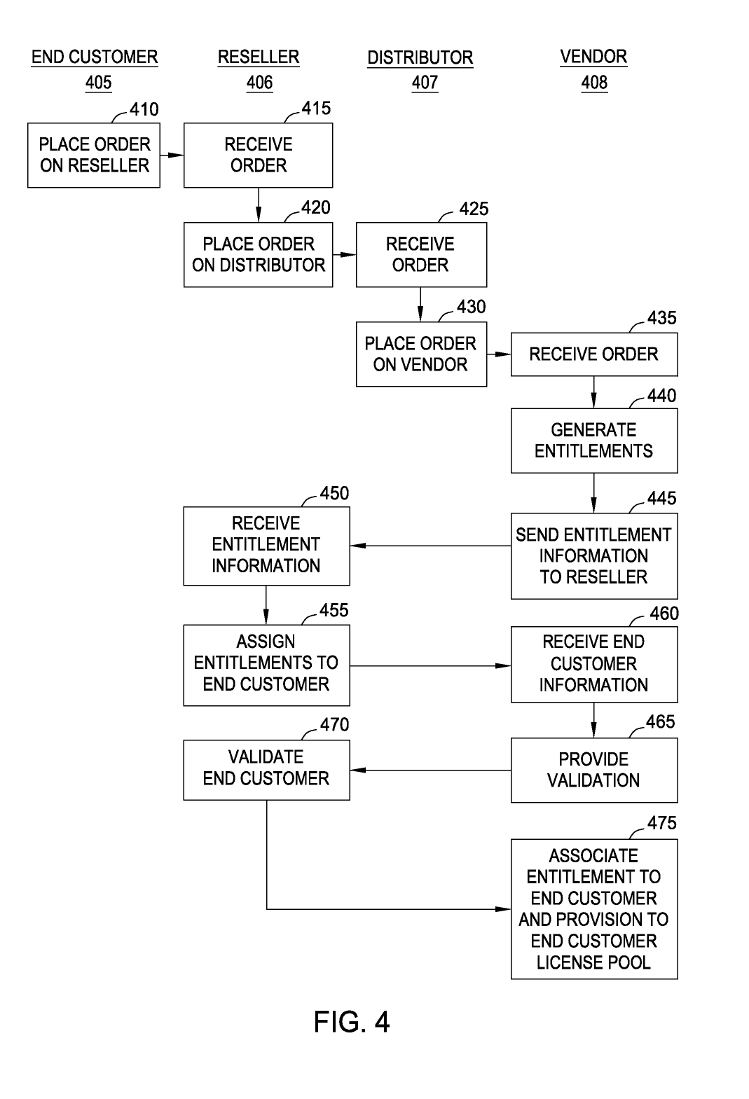

FIG. 4 illustrates a sequence diagram 400 of associating and provisioning license entitlements to a customer account on a vendor cloud, according to one embodiment. As shown, sequence 400 involves interactions between a customer 405, a reseller 406, a distributor 407, and a vendor 408. Reseller 406 and distributor 407 are channel partners of vendor 408. Customer 405 purchases products of vendor 408 through the channel partners.

The sequence begins at 410, where customer 410 places an order for a computer product of vendor 408 through reseller 406. Assume that customer 405 places an order for fifteen switches of vendor 408 from reseller 406. For example, customer 405 might place this order through an online form or website of reseller 406. In doing so, customer 405 might also supply a customer identifier in addition to the desired products.

Once reseller 406 receives the order (at 415), reseller 406 places the order for the computer product through distributor 407 (at 420). In one embodiment, reseller 406 may notify distributor 407 through an automated e-mail that includes the order specifications of customer 405 as well as contact information of reseller 406 (e.g., an e-mail address). Distributor 407 receives the order (at 425) and places the order through vendor 408 (at 430). In addition, distributor 407 includes the reseller 406 contact information with the order for the fifteen switches.

Vendor 408 receives the order (at 435). Vendor 408 generates entitlements in real-time based on the order specifications (at 440). Continuing the previous example, a vendor may generate entitlements for the switches that are based on a usage duration and where the switches may be used. In one embodiment, the entitlements may be embedded in a customizable license agreement and uploaded to a user portal where the customer (or reseller) may view the license agreement. Further, vendor 408 generates a token to associate with the entitlements. As stated, the token serves as a proof of entitlement for a customer. Vendor 408 notifies reseller 406 of the entitlements, passing along the associated token with the notification (e.g., by embedding the token in a URL link) (at 445). The notification may be an e-mail message providing reseller 406 with a link to a user portal to log into and view the entitlements as well as supply additional information for associating the entitlement data to the account of customer 405. Reseller 406 receives the entitlement notification from vendor 408 (at 450).

Reseller 406 assigns the entitlements to customer 405 (e.g., via supplying vendor 408 with a customer identifier and the provided token). Vendor 408 receives the information (at 460) and associates the entitlements with the token and provides a validation to reseller 406. In turn, reseller 406 validates customer 405 with vendor 408 (at 470). Thereafter, vendor 408 associates the entitlements to customer 405 and provisions the entitlements to a license pool associated with the customer account (at 475). In an alternative embodiment, rather than assigning the entitlements on behalf of customer 405, reseller 406 may forward the notification to customer 405 to view and tie the entitlements to the customer account. The steps on vendor-side remain the same in either case.

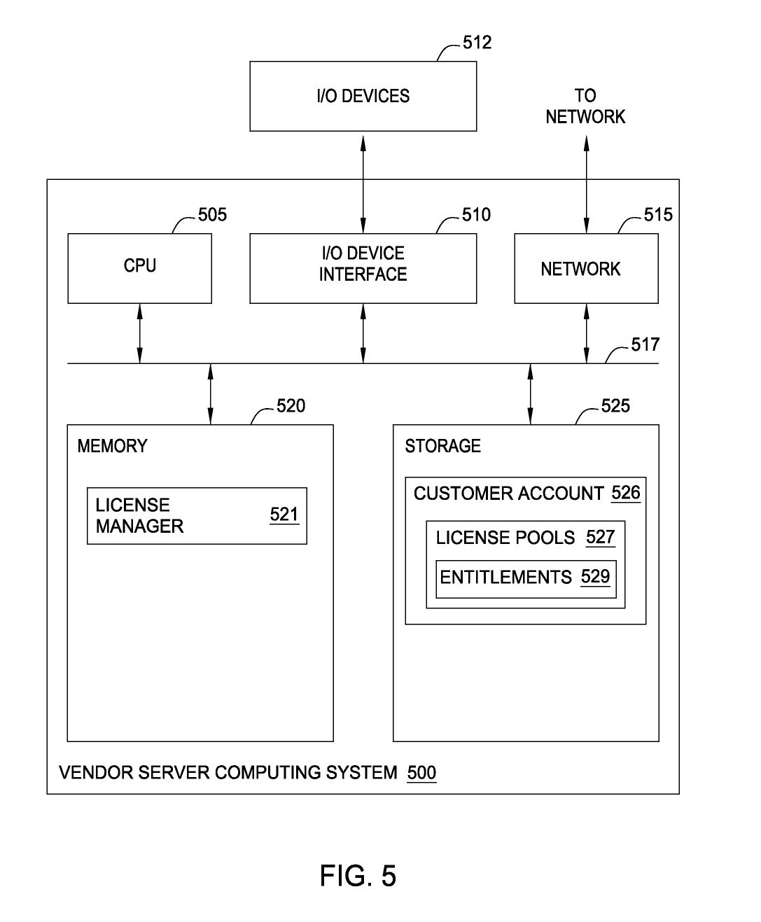

FIG. 5 illustrates a server computing system 500 of a vendor in the example licensing environment configured to generate entitlements and associate entitlements to a customer account, according to one embodiment. As shown, server computing system 500 includes, without limitation, a central processing unit (CPU) 505, an I/O device interface 510, a network interface 515, a memory 520, and a storage 525, each connected to a bus 517. The I/O device interface 510 connects I/O devices 512 (e.g., keyboard, display, and mouse devices) to server computing system 500. Further, in context of this description, the computing elements shown in server computing system 500 may correspond to a physical computing system (e.g., a system in a data center) or may be a virtual computing instance executing within a cloud computing environment.

The CPU retrieves and executes programming instructions stored in memory 520 and stores and retrieves application data residing in storage 525. Via bus 517, server computing system 500 transmits programming instructions and application data between CPU 505, I/O devices 510, storage 525, network interface 515, and memory 520. Note that CPU 505 is included to be representative of a single CPU having multiple processing cores, and/or the like. Memory 520 is included to be generally representative of a random access memory. Storage 525 may be a disk drive storage device. Although shown as a single unit, storage 525 may be a combination of fixed and/or removable storage devices, such as fixed disc drives, removable memory cards, or optical storage, network attached storage (NAS), or a storage area network (SAN).

Server computing system 500 hosts license manager 521 and license pool(s) 527 of a customer account 526. License manager 521 resides in memory 520. Storage 525 includes customer account information 526, which in turn includes license pool(s) 527 associated with license manager 521. License manager 521 generates license entitlements for customer purchases upon receiving orders from customers or partners acting on behalf of the customers. Further, when a customer or partner activates the product with the license manager, the license manager associates license entitlements to a particular customer account 526.

Note that license manager 521 may be further divided into components and run on separate server computing systems. For example, a separate license manager 521 may be configured to manage orders received from outside parties, whereas another license manager 521 on the vendor cloud may be configured to manage entitlement data. Similarly, the customer accounts 526 may be reside on a separate server computing system from license manager 521.

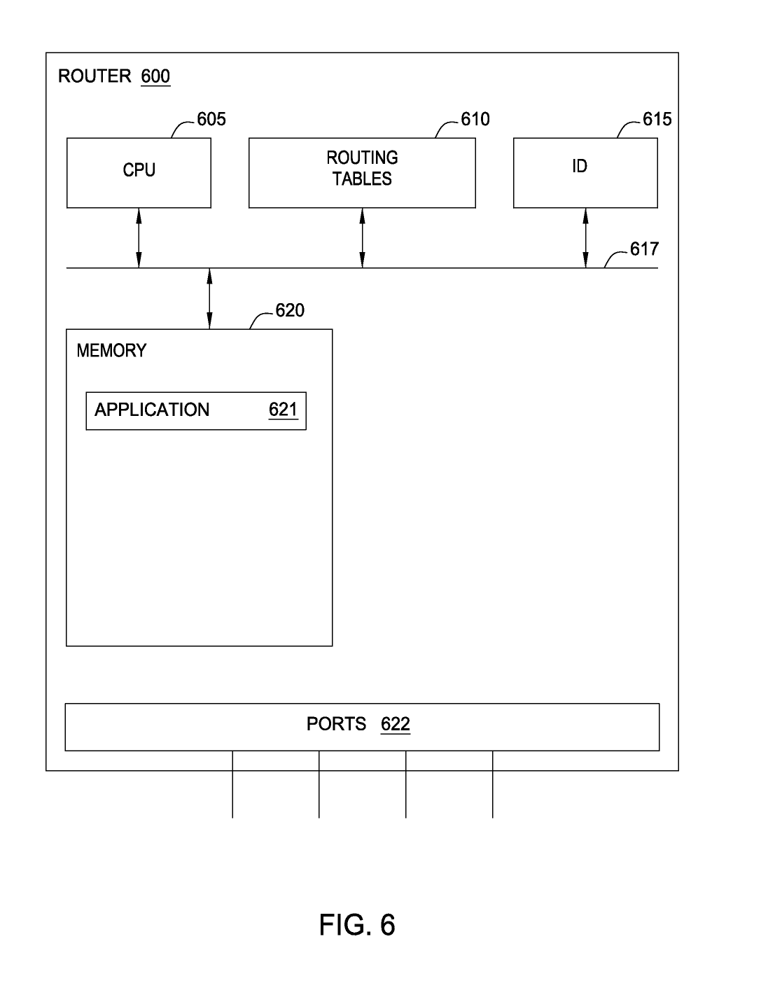

FIG. 6 illustrates a block diagram of an example router product 600 of the vendor, according to one embodiment. A customer may purchase router 600 and activate the router with the vendor. The vendor, during activation of router 600, may generate a license specific to the product and order specifications that the customer provides. In context of this description, the computing elements shown in router 600 correspond to hardware components and software modules (e.g., hardware and software in a datacenter).

As shown, router 600 includes, without limitation, a central processing unit (CPU) 605, an identifier 615, a memory 620, and ports 622, each connected to a bus 617. CPU 605 retrieves and executes programming instructions stored in memory 620, as well as stores and retrieves application data 642 and routing tables 610 residing in storage 640. Via bus 617, router 600 transmits programming instructions and application data 642 between CPU 605, identifier 615, memory 620, and ports 622. Note that CPU 605 is included to be representative of a single CPU, multiple CPUs, a single CPU having multiple processing cores, and the like. Memory 620 is included to be generally representative of a random access memory. Storage 640 may be a disk drive storage device.

On the vendor side, a license manager (e.g., residing on a memory of a server computing system on a vendor cloud network) is communicatively connected to router 600 via application 621. When a customer (or a partner acting on behalf of the customer) registers router 600, the license manager generates entitlements based on an order specification of the customer and associates the entitlements with router 600. The license manager sends the entitlement data to application 621 and manages customer use of router 600.

While the foregoing is directed to embodiments of the present disclosure, other and further embodiments of the disclosure may be devised without departing from the basic scope thereof. For example, aspects of the present disclosure may be implemented in hardware, software, or a combination of hardware and software. One embodiment of the disclosure may be implemented as a program product for use with a computer system. The program(s) of the program product define functions of the embodiments (including the methods described herein) and can be contained on a variety of computer-readable storage media. Illustrative non-transitory computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., a hard-disk drive or any type of solid-state random-access semiconductor memory) on which alterable information is stored. Such computer-readable storage media, when carrying computer-readable instructions that direct the functions of the present disclosure, are embodiments of the present disclosure.

Although embodiments of the present disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s).

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible or otherwise non-transitory medium that can contain, or store a program for use by or in connection with an instruction execution system, apparatus or device.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

Embodiments disclosed herein may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. A user can access any of the resources that reside in the cloud at any time, and from anywhere across the Internet.

In view of the foregoing, the scope of the present disclosure is determined by the claims that follow.

What is claimed is:

1. A computer-implemented method, comprising:
receiving, from a partner of a vendor, purchase information for computer products, wherein the partner sends the purchase information to the vendor on behalf of a customer;
generating, based on the purchase information, license entitlements and a token, wherein the token is associated with the license entitlements and used by the partner to access the license entitlements;
sending the token to the partner;
receiving, from the partner, a customer identifier; and
upon identifying the customer account corresponding to the customer identifier, provisioning the license entitlements to a set of one or more license entitlements associated with the account.

2. The method of claim 1, wherein the vendor monitors customer use of the license entitlements via a network accessible repository.

3. The method of claim 1, wherein the customer account is maintained on a cloud network of the vendor.

4. The method of claim 1, wherein the customer provides the partner with the customer identifier.

5. The method of claim 1, wherein the set of one or more license entitlements includes the license entitlements associated with computer products purchased from multiple vendors.

6. The method of claim 1, wherein sending the token to the partner further comprises, embedding the token as a uniform resource locator link in an entitlement notification to the partner.

7. The method of claim 1, wherein the set of one or more license entitlements is selected by the customer.

8. The method of claim 1, further comprising:
receiving, from a second partner, purchase information for additional computer products; wherein the second partner sends the purchase information to the vendor on behalf of the customer;
generating, based on the purchase information for the additional computer products, additional license entitlements and a second token;
sending the second token to the second partner;
receiving, from the second partner, the customer identifier; and
upon identifying the account corresponding to the customer identifier, provisioning the additional license entitlements to the set of one or more license entitlements.

9. A non-transitory computer-readable storage medium, storing code for execution by a processor, wherein the code, when executed by the processor, performs an operation, the operation comprising:
receiving, from a partner of a vendor, purchase information for computer products, wherein the partner sends the purchase information to the vendor on behalf of a customer;
generating, based on the purchase information, license entitlements and a token, wherein the token is associated with the license entitlements and used by the partner to access the license entitlements;
sending the token to the partner;
receiving, from the partner, a customer identifier; and
upon identifying the customer account corresponding to the customer identifier, provisioning the license entitlements to a set of one or more license entitlements associated with the account.

10. The computer-readable storage medium of claim 9, wherein the vendor monitors customer use of the license entitlements via a network accessible repository.

11. The computer-readable storage medium of claim 9, wherein the customer account is maintained on a cloud network of the vendor.

12. The computer-readable storage medium of claim 9, wherein the customer provides the partner with the customer identifier.

13. The computer-readable storage medium of claim 9, wherein the set of one or more license entitlements includes the license entitlements associated with computer products purchased from multiple vendors.

14. The computer-readable storage medium of claim 9, wherein sending the token to the partner further comprises, embedding the token as a uniform resource locator link in an entitlement notification to the partner.

15. The computer-readable storage medium of claim 9, wherein the set of one or more license entitlements is selected by the customer.

16. The computer-readable storage medium of claim 9, wherein the operation further comprises:
receiving, from a second partner, purchase information for additional computer products; wherein the second partner sends the purchase information to the vendor on behalf of the customer;
generating, based on the purchase information for the additional computer products, additional license entitlements and a second token;
sending the second token to the second partner;
receiving, from the second partner, the customer identifier; and
upon identifying the account corresponding to the customer identifier, provisioning the additional license entitlements to the set of one or more license entitlements.

17. A system, comprising:
a processor; and
a memory hosting an application, which, when executed on the processor, performs an operation, the operation comprising:
receiving, from a partner of a vendor, purchase information for computer products, wherein the partner sends the purchase information to the vendor on behalf of a customer;
generating, based on the purchase information, license entitlements and a token, wherein the token is associated with the license entitlements and used by the partner to access the license entitlements;
sending the token to the partner;
receiving, from the partner, a customer identifier; and
upon identifying the customer account corresponding to the customer identifier, provisioning the license entitlements to a set of one or more license entitlements associated with the account.

18. The system of claim 17, wherein the customer account is maintained on a cloud network of the vendor.

19. The system of claim 17, wherein the customer provides the partner with the customer identifier.

20. The system of claim 17, wherein sending the token to the partner further comprises, embedding the token as a uniform resource locator link in an entitlement notification to the partner.

21. The system of claim 17, wherein the operation further comprises:
receiving, from a second partner, purchase information for additional computer products; wherein the second partner sends the purchase information to the vendor on behalf of the customer;
generating, based on the purchase information for the additional computer products, additional license entitlements and a second token;
sending the second token to the second partner;
receiving, from the second partner, the customer identifier; and
upon identifying the account corresponding to the customer identifier, provisioning the additional license entitlements to the set of one or more license entitlements.
